(19) United States
(12) Patent Application Publication
(10) Pub. No.: US 2010/0281870 A1
(43) Pub. Date: Nov. 11, 2010

(54) SYSTEM AND METHOD FOR HEATING FUEL FOR A GAS TURBINE

(75) Inventors: Joel Donnell Holt, Schenectady, NY (US); Richard John Rucigay, Saratoga Springs, NY (US); Brian Jacob Berry, Niskayuna, NY (US); Gordon Raymond Smith, Schenectady, NY (US); Devkinandan Madhukar Tokekar, Schenectady, NY (US)

Correspondence Address: GE Energy-Global Patent Operation;Fletcher Yoder PC, P.O. Box 692289, Houston, TX, 77269-2289, US

(73) Assignee: General Electric Company, Schenectady, NY (US)

(21) Appl. No.: 12/437,737

(22) Filed: May 8, 2009

(51) Int. Cl. F02C 7/08; F02C 6/00

(52) U.S. Cl. 60/736; 60/39.182

(57) ABSTRACT

In certain embodiments, a system includes a fuel heater. The fuel heater includes a first heat exchanger configured to receive compressed air from a compressor and to transfer heat from the compressed air to feedwater. The fuel heater also includes a second heat exchanger configured to receive heated feedwater from the first heat exchanger and to transfer heat from the heated feedwater to a fuel.

### BACKGROUND OF THE INVENTION

The subject matter disclosed herein relates to the heating of fuel for a gas turbine.

Gas turbines typically use a mixture of fuel and compressed air for combustion. However, in some instances, the fuel may be at a relatively low temperature whereas the compressed air may be at a relatively high temperature. The low fuel temperature may reduce performance, reduce efficiency, and increase emissions of the gas turbine. Therefore, it may be desirable to heat the fuel before mixing it with the compressed air to improve the performance, efficiency, and emissions of the gas turbine.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a gas turbine engine. The gas turbine engine includes a compressor configured to receive and compress air. The gas turbine engine also includes a combustor configured to receive a first flow of the compressed air from the compressor and fuel, wherein the combustor is configured to combust a mixture of the compressed air and the fuel to generate an exhaust gas. The gas turbine engine further includes a turbine configured to receive the exhaust gas from the combustor and to utilize the exhaust gas to rotate a shaft. The system also includes a fuel system configured to receive a second flow of the compressed air from the compressor, to heat the fuel with heat from the second flow of the compressed air, and to deliver the heated fuel to the combustor.

In a second embodiment, a system includes a fuel heater. The fuel heater includes a first heat exchanger configured to receive compressed air from a compressor and to transfer heat from the compressed air to feedwater. The fuel heater also includes a second heat exchanger configured to receive heated feedwater from the first heat exchanger and to transfer heat from the heated feedwater to a fuel.

In a third embodiment, a method includes heating feedwater within a first heat exchanger using compressed air from a compressor as a first heat source. The method also includes heating fuel within a second heat exchanger using the heated feedwater from the first heat exchanger as a second heat source.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic flow diagram of an embodiment of a combined cycle power generation system having a gas turbine, a steam turbine, a heat recovery steam generation (HRSG) system, and a fuel system;

FIG. 2 is a schematic flow diagram of an embodiment of the gas turbine, air inlet system, and fuel system of FIG. 1;

FIG. 3 is a flow chart of an embodiment of a method for heating fuel in the fuel system of FIG. 1 using heated air from a compressor of the gas turbine of FIG. 1 as a heat source; and

FIG. 4 is a chart of temperature and mass flow rates of the heated air, fuel, and feedwater through an embodiment of the fuel system during startup.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments include systems and methods for heating fuel for a gas turbine using heated air from a compressor of the gas turbine. For instance, in certain embodiments, compressed air from the compressor may be directed into a first heat exchanger, where the compressed air is used to heat feedwater from a feedwater system. The feedwater may, for instance, be from intermediate-pressure sections of a heat recovery steam generation (HRSG) system. Next, the heated feedwater from the first heat exchanger may be directed into a second heat exchanger, where the heated feedwater is used to heat fuel before the fuel is delivered to the gas turbine for combustion. The use of feedwater as an intermediate heat transfer media eliminates the possibility of combining compressed air and fuel in the heat exchangers. Furthermore, since the feedwater system may already be used in conjunction with the gas turbine, especially in combined cycle power generation plants, the need for external heat transfer equipment (e.g., auxiliary boilers, electric heaters, and so forth) may be reduced or even eliminated. In other embodiments, a fluid other than feedwater may be used to transfer heat from the compressed air to the fuel via the first and second heat exchangers. Furthermore, other sources of heat, such as gas turbine exhaust, steam, and so forth, may be used to heat the intermediate heat transfer media. In addition, alternate heat exchanger configurations may also be used, including other intermediate heat transfer media.

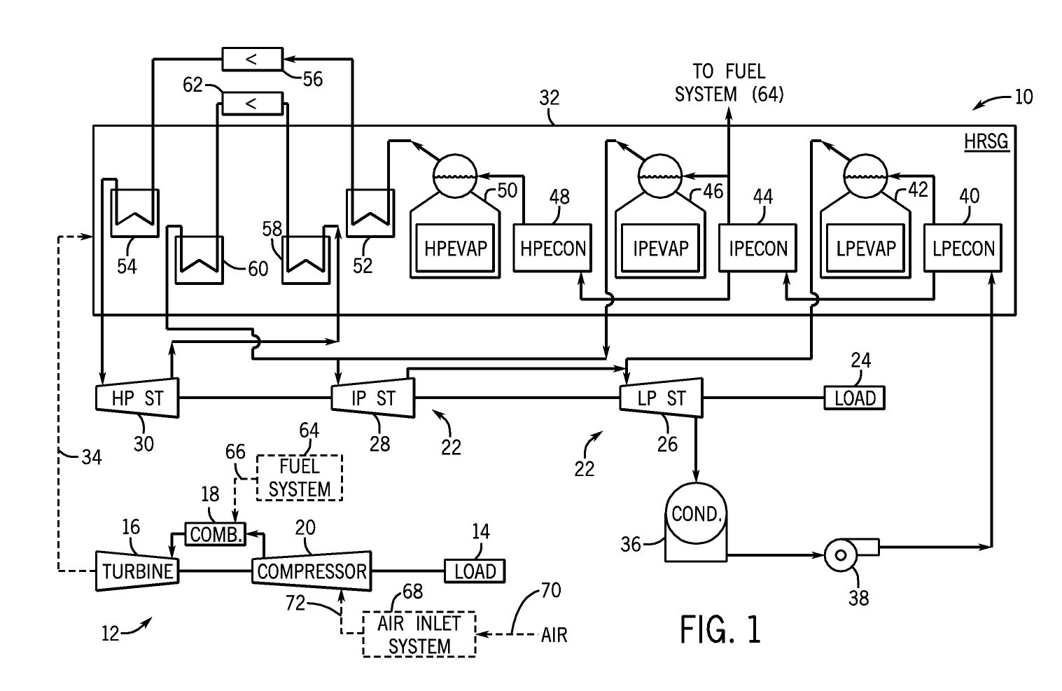

FIG. 1 is a schematic flow diagram of an embodiment of a combined cycle power generation system 10 having a gas turbine, a steam turbine, an HRSG system, and a fuel system. As described in greater detail below, the fuel system may be configured to heat fuel before delivering the fuel to the gas turbine. In particular, the fuel system may include a first heat exchanger for heating feedwater with heated, compressed air from a compressor of the gas turbine and a second heat exchanger for heating the fuel with heated feedwater from the first heat exchanger.

The system 10 may include a gas turbine 12 for driving a first load 14. The first load 14 may, for instance, be an electrical generator for producing electrical power. The gas turbine 12 may include a turbine 16, a combustor or combustion chamber 18, and a compressor 20. The system 10 may also include a steam turbine 22 for driving a second load 24. The second load 24 may also be an electrical generator for generating electrical power. However, both the first and second loads 14, 24 may be other types of loads capable of being driven by the gas turbine 12 and steam turbine 22. In addition, although the gas turbine 12 and steam turbine 22 may drive separate loads 14 and 24, as shown in the illustrated embodiment, the gas turbine 12 and steam turbine 22 may also be utilized in tandem to drive a single load via a single shaft. In the illustrated embodiment, the steam turbine 22 may include one low-pressure section 26 (LP ST), one intermediate-pressure section 28 (IP ST), and one high-pressure section 30 (HP ST). However, the specific configuration of the steam turbine 22, as well as the gas turbine 12, may be implementation-specific and may include any combination of sections.

The system 10 may also include a multi-stage HRSG 32. The components of the HRSG 32 in the illustrated embodiment are a simplified depiction of the HRSG 32 and are not intended to be limiting. Rather, the illustrated HRSG 32 is shown to convey the general operation of such HRSG systems. Heated exhaust gas 34 from the gas turbine 12 may be transported into the HRSG 32 and used to heat steam used to power the steam turbine 22. Exhaust from the low-pressure section 26 of the steam turbine 22 may be directed into a condenser 36. Condensate from the condenser 36 may, in turn, be directed into a low-pressure section of the HRSG 32 with the aid of a condensate pump 38.

The condensate may then flow through a low-pressure economizer 40 (LPECON), a device configured to heat feedwater with gases, which may be used to heat the condensate. From the low-pressure economizer 40, a portion of the condensate may be directed into a low-pressure evaporator 42 (LPEVAP) while the rest may be pumped toward an intermediate-pressure economizer 44 (IPECON). Steam from the low-pressure evaporator 42 may be returned to the low-pressure section 26 of the steam turbine 22. Likewise, from the intermediate-pressure economizer 44, a portion of the condensate may be directed into an intermediate-pressure evaporator 46 (IPEVAP) while the rest may be pumped toward a high-pressure economizer 48 (HPECON). In addition, steam and/or feedwater from the intermediate-pressure economizer 44 and/or the intermediate-pressure evaporator 46 may be sent to a fuel system, where it may be used to heat fuel for use in the combustion chamber 18 of the gas turbine 12. Steam from the intermediate-pressure evaporator 46 may be sent to the intermediate-pressure section 28 of the steam turbine 22. Again, the connections between the economizers, evaporators, and the steam turbine 22 may vary across implementations as the illustrated embodiment is merely illustrative of the general operation of an HRSG system that may employ unique aspects of the present embodiments.

Finally, condensate from the high-pressure economizer 48 may be directed into a high-pressure evaporator 50 (HPEVAP). Steam exiting the high-pressure evaporator 50 may be directed into a primary high-pressure superheater 52 and a finishing high-pressure superheater 54, where the steam is superheated and eventually sent to the high-pressure section 30 of the steam turbine 22. Exhaust from the high-pressure section 30 of the steam turbine 22 may, in turn, be directed into the intermediate-pressure section 28 of the steam turbine 22. Exhaust from the intermediate-pressure section 28 of the steam turbine 22 may be directed into the low-pressure section 26 of the steam turbine 22.

An inter-stage attemperator 56 may be located in between the primary high-pressure superheater 52 and the finishing high-pressure superheater 54. The inter-stage attemperator 56 may allow for more robust control of the exhaust temperature of steam from the finishing high-pressure superheater 54. Specifically, the inter-stage attemperator 56 may be configured to control the temperature of steam exiting the finishing high-pressure superheater 54 by injecting cooler feedwater spray into the superheated steam upstream of the finishing high-pressure superheater 54 whenever the exhaust temperature of the steam exiting the finishing high-pressure superheater 54 exceeds a predetermined value.

In addition, exhaust from the high-pressure section 30 of the steam turbine 22 may be directed into a primary re-heater 58 and a secondary re-heater 60 where it may be re-heated before being directed into the intermediate-pressure section 28 of the steam turbine 22. The primary re-heater 58 and secondary re-heater 60 may also be associated with an inter-stage attemperator 62 for controlling the exhaust steam temperature from the re-heaters. Specifically, the inter-stage attemperator 62 may be configured to control the temperature of steam exiting the secondary re-heater 60 by injecting cooler feedwater spray into the superheated steam upstream of the secondary re-heater 60 whenever the exhaust temperature of the steam exiting the secondary re-heater 60 exceeds a predetermined value.

In combined cycle systems such as system 10, hot exhaust gas 34 may flow from the gas turbine 12 and pass through the HRSG 32 and may be used to generate high-pressure, high-temperature steam. The steam produced by the HRSG 32 may then be passed through the steam turbine 22 for power generation. In addition, the produced steam may also be supplied to any other processes where superheated steam may be used. The gas turbine 12 cycle is often referred to as the “topping cycle,” whereas the steam turbine 22 generation cycle is often referred to as the “bottoming cycle.” By combining these two cycles as illustrated in FIG. 1, the combined cycle power generation system 10 may lead to greater efficiencies in both cycles. In particular, exhaust heat from the topping cycle may be captured and used to generate steam for use in the bottoming cycle.

The gas turbine 12 may be operated using fuel from a fuel system 64. In particular, the fuel system 64 may supply the gas turbine 12 with fuel 66, which may be burned within the combustion chamber 18 of the gas turbine 12. The fuel 66 may include liquid fuel, gas fuel, or a combination thereof. In addition, in certain embodiments, an air inlet system 68 may be used to collect ambient air 70 for use as inlet air 72, which may be compressed within the compressor 20 of the gas turbine 12.

To ensure efficient combustion of the fuel 66 within the combustion chamber 18 of the turbine 12, in certain embodiments, the fuel system 64 may include equipment for heating the fuel 66 before delivering the fuel 66 to the combustion chamber 18. More specifically, by heating the fuel 66 before delivering the fuel 66 to the combustion chamber 18, the performance, efficiency, and emissions of the combined cycle power generation system 10 may be improved. In particular, heating the fuel 66 during startup of the combined cycle power generation system 10 may prove particularly beneficial since the fuel 66 will generally be cooler than the compressed air delivered to the combustion chamber 18 from the compressor 20 during startup.

One solution for heating the fuel 66 is to use auxiliary boilers with steam as the heating source. However, using auxiliary boilers to heat the fuel 66 may involve certain drawbacks. For example, the capital cost of installing auxiliary boilers may not be the most efficient use of resources in that the auxiliary boilers may generally be larger than what is actually needed. The embodiments disclosed herein are generally directed toward addressing these drawbacks. In particular, as described in greater detail below, the disclosed embodiments provide for using heated, compressed air from the compressor 20 of the gas turbine 12 to heat feedwater which, in turn, may be used to heat the fuel 66 before it is delivered to the combustion chamber 18 of the gas turbine 12. Since the heated, compressed air from the compressor 20 and the feedwater may already be used by the combined cycle power generation system 10, using them to heat the fuel 66 may reduce capital costs for the plant by reducing the need for external heat transfer equipment, such as the auxiliary boilers.

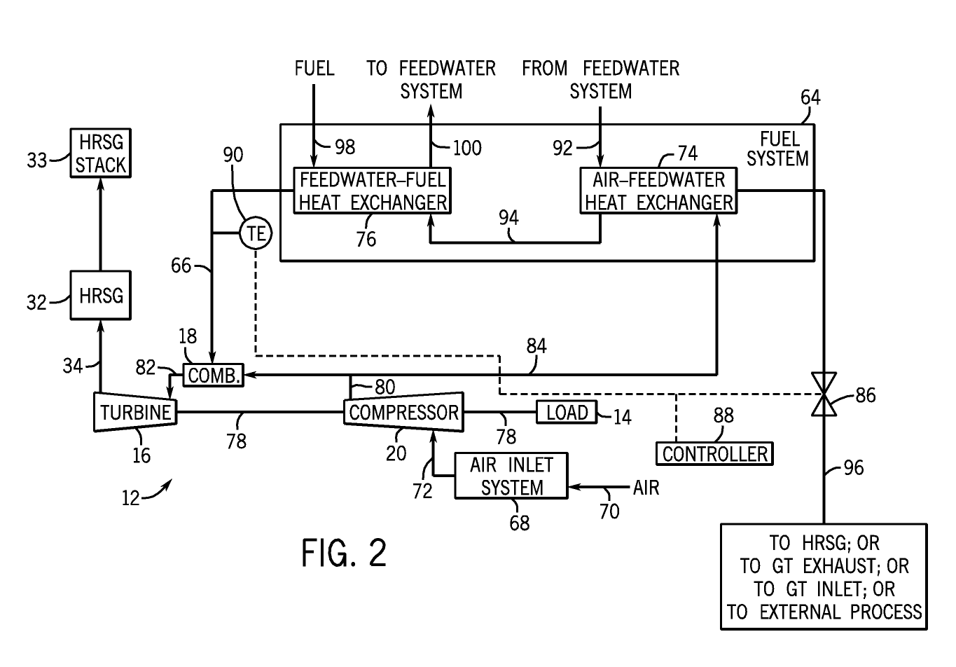

FIG. 2 is a schematic flow diagram of an embodiment of the gas turbine 12, air inlet system 68, and fuel system 64 of FIG. 1. As illustrated, the fuel system 64 may include an air-feedwater heat exchanger 74 and a feedwater-fuel heat exchanger 76. As described in greater detail below, the air-feedwater heat exchanger 74 may be used to heat feedwater using heated, compressed air from the compressor 20 of the gas turbine 12 as a source of heat. In addition, the feedwater-fuel heat exchanger 76 may be used to heat fuel using the heated feedwater as a source of heat. Therefore, in general, the fuel system 64 may receive heated, compressed air from the compressor 20 of the gas turbine 12 and may generate heated fuel 66 for use in the combustion chamber 18 of the gas turbine 12.

To better illustrate the process of heating the fuel 66 with heated, compressed air from the compressor 20 of the gas turbine 12, an overview of how the gas turbine 12 generally operates will be provided. As illustrated, the turbine 16 and the compressor 20 may be coupled to a common shaft 78, which may also be connected to the load 14. The compressor 20 also includes blades that may be coupled to the shaft 78. As the shaft 78 rotates, the blades within the compressor 20 also rotate, thereby compressing the inlet air 72 from the air inlet system 68. The compressed air 80 may be directed into the combustion chamber 18 of the gas turbine 12, where the compressed air 80 is mixed with the fuel 66 for combustion within combustion chamber 18. More specifically, fuel nozzles may inject the air-fuel mixture into the combustion chamber 18 in a suitable ratio for optimal combustion, emissions, fuel consumption, and power output. The air-fuel mixture combusts within the combustion chamber 18, thereby creating hot pressurized exhaust gases 82. The combustion chamber 18 directs the exhaust gases 82 through the turbine 16. As the exhaust gases 82 pass through the turbine 16, the gases force one or more turbine blades to rotate the shaft 78 and, in turn, the compressor 20 and the load 14. More specifically, the rotation of the turbine blades causes rotation of the shaft 78, thereby causing blades within the compressor 20 to draw in and pressurize the inlet air 72 received from the air inlet system 68.

The compressed air 80 that is generated by the compressor 20 may not only be at an elevated pressure but may also be at an elevated temperature. For instance, in certain embodiments, the compressed air 80 generated by the compressor 20 may be in the range of 500° F. (e.g., at a minimum load on the gas turbine 12) to 800° F. (e.g., at a maximum load on the gas turbine 12). However, the temperature of the compressed air 80 may vary between implementations and operating points and may, in certain embodiments, be 400° F., 450° F., 500° F., 550° F., 600° F., 650° F., 700° F., 750° F., 800° F., 850° F., 900° F., and so forth. In addition, the temperature of the compressed air 80 may vary between different stages of the compressor 20.

Therefore, the compressed air 80 is generally at an elevated temperature, particularly compared to the fuel 66. Therefore, instead of the entire flow of compressed air 80 being directed into the combustion chamber 18 of the gas turbine 12, a certain amount of the compressed air 80 may be directed or bypassed into the fuel system 64 as heated air 84, for use within the air-feedwater heat exchanger 74 as a source of heat. For example, in certain embodiments, a certain percentage (e.g., 0-20 percent) of the compressed air 80 may be directed toward the air-feedwater heat exchanger 74. In certain embodiments, the percentage of heated air 84 taken from the main flow of compressed air 80 may be in the order of 1% to 3%. However, the percentage of heated air 84 taken from the main flow of compressed air 80 may also vary between implementations and operating points and may, in certain embodiments, be 0.5%, 1.0%, 1.5%, 2.0%, 2.5%, 3.0%, 3.5%, 4.0%, 4.5%, 5.0%, and so forth. These percentages may also be based on various characteristics of the compressed air 80, such as volume, mass, and so forth. Indeed, in addition to certain percentages being re-directed into the air-feedwater heat exchanger 74, certain mass flow rates, energy flow rates, and so forth, needed to heat the fuel 66 may determine how much heated air 84 should be directed into the air-feedwater heat exchanger 74.

In certain embodiments, the distribution of the compressed air 80 between the combustion chamber 18 of the gas turbine 12 and the air-feedwater heat exchanger 74 of the fuel system 64 may be controlled by a valve 86 downstream of the air-feedwater heat exchanger 74. In particular, the valve 86 may control the amount of heated air 84 to be delivered into the air-feedwater heat exchanger 74. In certain embodiments, a controller 88 may be used to control the flow of the heated air 84. In particular, the controller 88 may include control logic for actuating the valve 86 to control the flow of the compressed air 80 to the air-feedwater heat exchanger 74 of the fuel system 64. In certain embodiments, the flow of the compressed air 80 and the heated air 84 may be adjusted by the controller 88 based at least in part on conditions within the air-feedwater heat exchanger 74 and the feedwater-fuel heat exchanger 76. For example, the distribution of the compressed air 80 between the combustion chamber 18 and the air-feedwater heat exchanger 74 may be controlled by the controller 88 based on the temperature of the fuel 66 delivered from the feedwater-fuel heat exchanger 76 to the combustion chamber 18, which may be measured by a temperature sensor 90.

As described above, the heated air 84 directed into the air-feedwater heat exchanger 74 may be used to heat feedwater 92 from a feedwater system of the combined cycle power generation system 10. In particular, in certain embodiments, intermediate-pressure feedwater from the HRSG 32 may be heated within the air-feedwater heat exchanger 74. More specifically, in certain embodiments, the intermediate-pressure feedwater may be received from the intermediate-pressure economizer 44 and/or the intermediate-pressure evaporator 46 of the HRSG 32. However, in other embodiments, high-pressure feedwater from the HRSG 32 may also be heated within the air-feedwater heat exchanger 74. In general, the feedwater 92 heated within the air-feedwater heat exchanger 74 may be at a substantially lower temperature than the heated air 84 from the compressor 20 of the gas turbine 12. For example, in certain embodiments, the temperature of the feedwater 92 may be on the order of 80° F. to 300° F. However, again, the temperature of the feedwater 92 may vary between implementations and operating points and may, in certain embodiments, be 60° F., 80° F., 100° F., 120° F., 140° F., 160° F., 180° F., 200° F., 220° F., 240° F., 260° F., 280° F., 300° F., 320° F., 340° F., and so forth.

Therefore, the heated gas 84 may be used to heat the feedwater 92 to create heated feedwater 94, which may be directed into the feedwater-fuel heat exchanger 76. During the process, the heated air 84 will be cooled to a certain degree, generating cooled air 96. In certain embodiments, the cooled air 96 may be directed back into the air inlet system 68, where the cooled air 96 may again be sent to the compressor 20 of the gas turbine as inlet air 72. However, in other embodiments, the cooled air 96 may be directed to the HRSG stack 33, an exhaust of the gas turbine 12, or other external process. In certain embodiments, the temperature of the feedwater 92 may be increased to approximately 425° F. while the temperature of the heated air 84 may be decreased to approximately 140° F. to 240° F. As before, the amount of heat exchange will vary between implantations and operating points. As such, the temperature of the heated feedwater 94 delivered to the feedwater-fuel heat exchanger 76 may vary between 350° F., 375° F., 400° F., 425° F., 450° F., 475° F., 500° F., and so forth, while the temperature of the cooled air 96 delivered back to the air inlet system 68 may vary between 100° F., 120° F., 140° F., 160° F., 180° F., 200° F., 220° F., 240° F., 260° F., 280° F., 300° F., and so forth. Therefore, in certain embodiments, the temperature of the feedwater 92 may increase by 10, 20, 30, 40, 50, 60, 70, 80, 90, 100%, or more on a Rankine scale, while the temperature of the heated air 84 may decrease by 5, 10, 15, 20, 25, 30, 35, 40, 45, 50%, or more on a Rankine scale.

The heated feedwater 94 directed into the feedwater-fuel heat exchanger 76 may be used to heat a source fuel 98. In general, the source fuel 98 heated within the feedwater-fuel heat exchanger 76 may be at a substantially lower temperature than the heated feedwater 94 from the air-feedwater heat exchanger 74. For example, in certain embodiments, the temperature of the source fuel 98 may be approximately 60° F. However, again, the temperature of the source fuel 98 may vary between implementations and operating points and may, in certain embodiments, be 40° F., 50° F., 60° F., 70° F., 80° F., 90° F., 100° F., 110° F., 120° F., and so forth.

Therefore, the heated feedwater 94 may be used to heat the source fuel 98 to create heated fuel 66, which may be directed into the combustion chamber 18 of the gas turbine 12. During the process, the feedwater 94 will be cooled to a certain degree, generating cooled feedwater 100. The cooled feedwater 100 may be directed back into the feedwater system of the combined cycle power generation system 10. In certain embodiments, the temperature of the source fuel 98 may be increased to approximately 375° F. while the temperature of the heated feedwater 94 may be decreased to approximately 120° F. As before, the amount of heat exchange will vary between implantations and operating points. As such, the temperature of the heated fuel 66 to be delivered to the combustion chamber 18 of the gas turbine 12 may vary between 300° F., 325° F., 350° F., 375° F., 400° F., 425° F., 450° F., and so forth, while the temperature of the cooled feedwater 100 delivered back to the feedwater system of the of the combined cycle power generation system 10 may vary between 80° F., 90° F., 100° F., 110° F., 120° F., 130° F., 140° F., 150° F., 160° F., and so forth. Therefore, in certain embodiments, the temperature of the source fuel 98 may increase by 10, 20, 30, 40, 50, 60, 70, 80, 90, 100%, or more on a Rankine scale, while the temperature of the heated feedwater 94 may decrease by 5, 10, 15, 20, 25, 30, 35, 40, 45, 50%, or more on a Rankine scale.

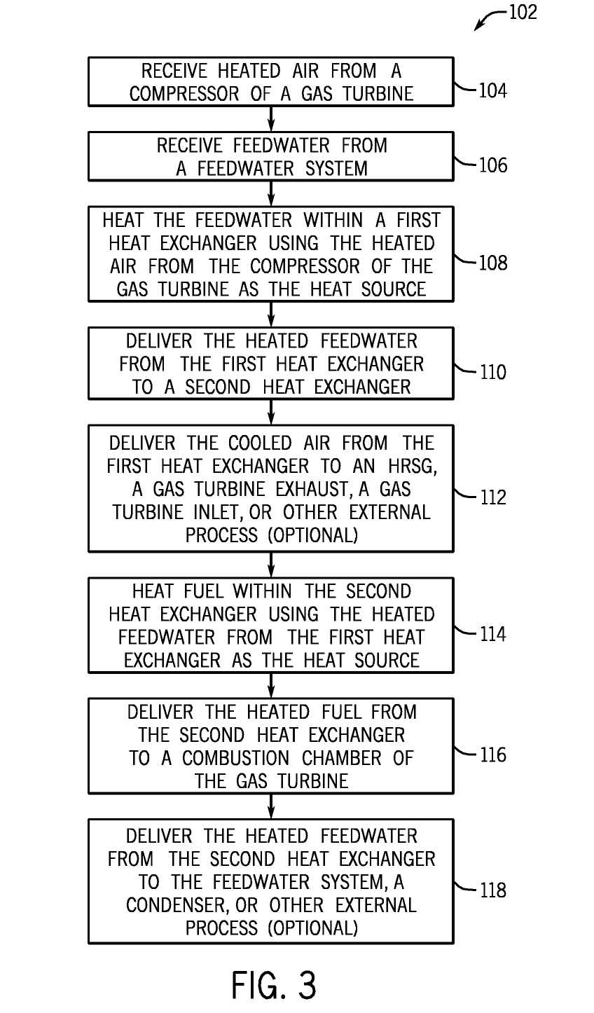

FIG. 3 is a flow chart of an embodiment of a method 102 for heating the fuel in the fuel system 64 using the heated air 84 from the compressor 20 of the gas turbine 12 as a heat source. In step 104, the fuel system 64 may receive the heated air 84 from the compressor 20. As described above, the controller 88 may be used to determine how much heated air 84 should be delivered to the fuel system 64 for use as a heat source. For example, if the temperature of the fuel 66 measured by the temperature sensor 90 is below a target value, the controller 88 may determine that the amount of heated air 84 delivered to the fuel system 64 should be increased. Accordingly, the controller 88 may actuate the valve 86 to increase the flow rate of the heated air 84 into the fuel system 64. Conversely, if the temperature of the fuel 66 measured by the temperature sensor 90 is above a target value, the controller 88 may determine that the amount of heated air 84 delivered to the fuel system 64 should be decreased. Accordingly, the controller 88 may actuate the valve 86 to decrease the flow rate of the heated air 84 into the fuel system 64.

In step 106, the fuel system 64 may receive feedwater 92. As described above, the feedwater 92 may be used as the intermediate heat transfer media for heating the fuel 66. The two-step process of first heating the feedwater 92 with the heated gas 84 in the air-feedwater heat exchanger 74 and then heating the source fuel 98 with the heated feedwater 94 in the feedwater-fuel heat exchanger 76 is generally beneficial in that the possibility of creating a combustible air-fuel mixture in the fuel system 64 is reduced. In other words, since the feedwater 92 is used as an intermediate heat transfer media, there is less of a chance that the heated air 84 and the source fuel 98 will mix, creating an undesirably combustible situation in the fuel system 64.

The feedwater 92 may be received from any suitable feedwater system within or external to the combined cycle power generation system 10. However, as described above, in certain embodiments, the feedwater 92 may be received from the HRSG 32 and, more specifically, from the intermediate-pressure economizer 44 and/or the intermediate-pressure evaporator 46 of the HRSG 32. Feedwater from the intermediate-pressure sections of the HRSG 32 has been found to be a particularly suitable intermediate heat transfer media within the fuel system 64. However, as described above, high-pressure feedwater from the HRSG 32 may also be used as the intermediate heat transfer media.

In step 108, the feedwater 92 may be heated within the air-feedwater heat exchanger 74 using the heated air 84 from the compressor 20 of the gas turbine 12 as the heat source. In other words, heat will be transferred from the heated gas 84 to the feedwater 92 within the air-feedwater heat exchanger 74. Any suitable heat exchanger design capable of transferring heat from a gas (e.g., the heated air 84) to a fluid (e.g., the feedwater 92) may be used. During step 108, the feedwater 92 will be heated to become the heated feedwater 94, which will be directed into the feedwater-fuel heat exchanger 76 while the heated air 84 will be cooled to become the cooled air 96.

In step 110, the heated feedwater 94 from the air-feedwater heat exchanger 74 may be delivered to the feedwater-fuel heat exchanger 76. Additionally, in step 112, the cooled air 96 from the air-feedwater heat exchanger 74 may optionally be directed back toward the gas turbine 12. More specifically, as described above, the cooled air 96 may be directed into the air inlet system 68 associated with the compressor 20 of the gas turbine 12. However, in other embodiments, the cooled air 96 may be directed to the HRSG stack 33, an exhaust of the gas turbine, or other external process.

In step 114, the source fuel 98 may be heated within the feedwater-fuel heat exchanger 76 using the heated feedwater 94 from the air-feedwater heat exchanger 74 as the heat source. In other words, heat will be transferred from the heated feedwater 94 to the source fuel 98 within the feedwater-fuel heat exchanger 76. Any suitable heat exchanger design capable of transferring heat from a fluid (e.g., the heated feedwater 94) to the fuel may be used. During step 114, the source fuel 98 will be heated to become the fuel 66 which will be directed into the combustion chamber 18 of the gas turbine 12, while the heated feedwater 98 will be cooled to become the cooled feedwater 100 which may be directed back into the feedwater system from which the feedwater 92 came.

In step 116, the fuel 66 which has been heated within the feedwater-fuel heat exchanger 76 may be delivered to the combustion chamber 18 of the gas turbine 12. As described above, in certain embodiments, the temperature of the fuel 66 from the feedwater-fuel heat exchanger 76 may be monitored by the controller 88 via the temperature sensor 90 to determine whether the flow rate of the heated air 84 into the fuel system 64 should be increased, decreased, or maintained at the current flow rate. In addition, in step 118, the cooled feedwater 100 may optionally be directed back into the feedwater system from which the feedwater 92 came. For example, in certain embodiments, the cooled feedwater 100 may be directed back into the HRSG 32 and, more specifically, into the intermediate-pressure sections (e.g., the intermediate-pressure economizer 44 and/or the intermediate-pressure evaporator 46) of the HRSG 32. However, in other embodiments, the cooled feedwater 100 may be directed into the condenser 36 or other external process.

Although the systems and methods described herein may be used at any time during operation of the gas turbine 12 and the combined cycle power generation system 10, the embodiments disclosed herein may be particularly useful during startup of the gas turbine 12 and the combined cycle power generation system 10. After an initial startup period, temperatures of the feedwater 92 in the feedwater system may begin to increase. At this point, the feedwater 92 from the feedwater system may be used to directly heat the fuel. For example, the feedwater 92 may flow through the air-feedwater heat exchanger 74 (e.g., with no heating) into the feedwater-fuel heat exchanger 76, where the feedwater 92 may be used to directly heat the source fuel 98.

More specifically, in certain embodiments, the controller 88 may detect when the temperature of the feedwater 92 from the feedwater system increases to a desired temperature (e.g., 350° F., 375° F., 400° F., 425° F., 450° F., 475° F., 500° F., and so forth). At this point, the controller 88 may determine that the heated air 84 from the compressor 20 of the gas turbine 12 is no longer needed to heat the feedwater 92. Therefore, the controller 88 may cause all of the compressed air 80 from the compressor 20 to be directed into the combustion chamber 18 of the gas turbine 12. As such, no heating will occur within the air-feedwater heat exchanger 74. Instead, the feedwater 92 from the feedwater system will flow through the air-feedwater heat exchanger 74 (e.g., with no heating) into the feedwater-fuel heat exchanger 76. In other embodiments, the controller 88 may cause the feedwater 92 from the feedwater system to entirely bypass the air-feedwater heat exchanger 74.

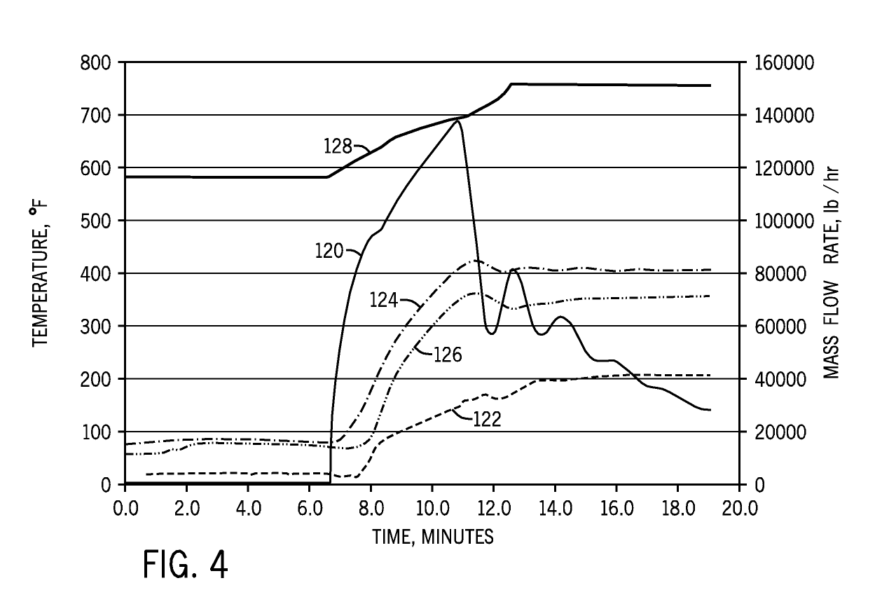

The amount of time to bring the feedwater 92 from the feedwater system up to a desired temperature may only take approximately 5 minutes or so. For example, FIG. 4 is a chart of temperature and mass flow rates of the heated air 84, the fuel 66, and the feedwater 92 through an embodiment of the fuel system 64 during startup. As illustrated, at around 6.5 minutes, the heated air mass flow rate 120 delivered to the air-feedwater heated exchanger 74 may begin increasing. As such, the feedwater mass flow rate 122 will begin increasing so that the heated air 84 has something to heat. In addition, the feedwater inlet temperature 124 into the feedwater-fuel heat exchanger 76 and the fuel outlet temperature 126 out of the feedwater-fuel heat exchanger 76 will also begin increasing. Furthermore, the heated air temperature 128 will gradually begin increasing. At some point, the feedwater inlet temperature 124 and/or the fuel outlet temperature 126 may reach a desired target. In the illustrated embodiment, that point is around the 11-minute mark. Once this happens, the heated air mass flow rate 120 may begin decreasing. However, at this point, the feedwater mass flow rate 122, the feedwater inlet temperature 124, the fuel outlet temperature 126, and the heated air temperature 128 may all remain relatively constant or gradually stabilize. As described above, this is primarily due to the fact that the feedwater 92 from the feedwater system has reached a high enough temperature that the feedwater 92 may be used to directly heat the fuel in the feedwater-fuel heat exchanger 76. It should be noted that all of the values mentioned with respect to FIG. 5 are merely illustrative of a typical startup period and are not intended to be limiting.

Technical effects of the disclosed embodiments include providing systems and methods for heating fuel for use in a gas turbine using compressed air from a compressor of the gas turbine as a source of heat. More specifically, a first heat exchanger may be used to heat feedwater with the heated, compressed air. Next, the heated feedwater may be directed into a second heat exchanger where the heated feedwater may be used to heat the fuel. By using the feedwater as an intermediate heat transfer media, the possibility of combustion of the air-fuel mixture in the first and second heat exchangers is reduced. In addition, since existing air from the compressor of the gas turbine and feedwater from the feedwater system may be used to heat the fuel, the need for external heat transfer equipment (e.g., auxiliary boilers, electric heaters, and so forth) may be reduced or even eliminated, thereby reducing capital costs. It should be noted that other heat exchanger configurations and/or intermediate heat transfer media may be used in conjunction with the disclosed systems and methods.

In addition, the disclosed embodiments solve the problem of fuel heating during fast starting of the gas turbine 12. In particular, the disclosed embodiments ensure satisfactory fuel temperatures such that the gas turbine 12 may be operated in an unrestricted manner. Additionally, as opposed to re-introducing the cooled air 96 from the fuel system 64 back into the gas turbine 12, the disclosed embodiments enable re-routing of the cooled air 96 from the fuel system 64 to an inlet of the gas turbine 12, an exhaust of the gas turbine 12, or to the HRSG stack 33. Again, this ensures that the gas turbine 12 may be operated in an unrestricted manner, rather than being constrained by the re-introduction of cooled air 96.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a gas turbine engine, comprising:
a compressor configured to receive and compress air;
a combustor configured to receive a first flow of the compressed air from the compressor and fuel, wherein the combustor is configured to combust a mixture of the compressed air and the fuel to generate an exhaust gas; and
a turbine configured to receive the exhaust gas from the combustor and to utilize the exhaust gas to rotate a shaft; and
a fuel system configured to receive a second flow of the compressed air from the compressor, to heat the fuel with heat from the second flow of the compressed air, and to deliver the heated fuel to the combustor.

2. The system of claim 1, comprising a valve configured to adjust the second flow of the compressed air to the fuel system.

3. The system of claim 2, comprising a controller configured to control the valve based at least in part on the temperature of the heated fuel from the fuel system.

4. The system of claim 1, wherein the fuel system comprises a first heat exchanger configured to heat feedwater with the second flow of compressed air and a second heat exchanger configured to heat the fuel with the heated feedwater from the first heat exchanger.

5. The system of claim 4, wherein the fuel system is configured to receive the feedwater from a heat recovery steam generation system.

6. The system of claim 4, wherein the fuel system is configured to deliver the heated feedwater to a heat recovery steam generation system.

7. The system of claim 1, wherein the gas turbine engine is a topping cycle of a combined cycle power generation system.

8. The system of claim 1, wherein the fuel system is configured to deliver the second flow of the compressed air to an inlet of the gas turbine engine.

9. A system, comprising:
a fuel heater, comprising:
a first heat exchanger configured to receive compressed air from a compressor and to transfer heat from the compressed air to feedwater; and
a second heat exchanger configured to receive heated feedwater from the first heat exchanger and to transfer heat from the heated feedwater to a fuel.

10. The system of claim 9, wherein the fuel heater is a gas turbine fuel heater configured to use the compressor of a gas turbine engine to heat the fuel for the gas turbine engine.

11. The system of claim 9, wherein the first heat exchanger is configured to receive the feedwater from a heat recovery steam generation system.

12. The system of claim 11, wherein the feedwater comprises intermediate-pressure feedwater from an intermediate-pressure section of the heat recovery steam generation system or high-pressure feedwater from a high-pressure section of the heat recovery steam generation system.

13. The system of claim 9, wherein the second heat exchanger is configured to deliver the heated feedwater to a heat recovery steam generation system.

14. The system of claim 9, wherein the fuel heater is configured to operate both the first and second heat exchangers in a first mode and to operate only the second heat exchanger in a second mode.

15. The system of claim 9, wherein the first and second heat exchangers are configured to operate together during a start-up period of a gas turbine engine and a heat recovery steam generation system, and the second heat exchanger is configured to operate without the first heat exchanger after the start-up period.

16. A method, comprising:
heating feedwater within a first heat exchanger using compressed air from a compressor as a first heat source; and
heating fuel within a second heat exchanger using the heated feedwater from the first heat exchanger as a second heat source.

17. The method of claim 16, comprising exchanging the feedwater with a heat recovery steam generation system.

18. The method of claim 16, comprising delivering the heated fuel from the second heat exchanger to a combustion chamber of a gas turbine engine.

19. The method of claim 16, comprising controlling the flow of the compressed air between the first heat exchanger and a combustion chamber of a gas turbine engine.

20. The method of claim 16, comprising operating both the first and second heat exchangers during a start-up period of a gas turbine engine and a heat recovery steam generation system, and operating only the second heat exchanger after the start-up period.
